(19) United States
(12) Patent Application Publication
(10) Pub. No.: US 2026/0328228 A1
(43) Pub. Date: Oct. 22, 2026

(54) LOADING METHOD AND SYSTEM FOR ELECTRO-HYDROSTATIC ACTUATOR UNDERWATER WORKING CONDITIONS SIMULATION TEST

(71) Applicant: Zhejiang University, Zhejiang (CN)

(72) Inventors: Zheng Chen, Zhejiang (CN); Yang Chen, Zhejiang (CN); Zhenhui Li, Zhejiang (CN); Jiajia Liu, Zhejiang (CN); Chaokun Yang, Zhejiang (CN); Xiang Chen, Zhejiang (CN); Yong Nie, Zhejiang (CN); Deqing Mei, Zhejiang (CN)

(73) Assignee: Zhejiang University, Zhejiang (CN)

(21) Appl. No.: 19/466,495

(22) Filed: Feb. 1, 2026

(30) Foreign Application Priority Data
Apr. 21, 2025 (CN) 202510495721.2

(51) Int. Cl. F15B 19/00; G01M 13/003; G01M 99/00

(52) U.S. Cl. CPC F15B 19/007; G01M 13/003; G01M 99/007

(57) ABSTRACT

The present invention discloses an electro-hydrostatic actuator underwater working conditions simulation test system and loading method. The present invention is based on a test system mainly comprising a gear pump, pressure compensators, a loading valve group and a loading hydraulic cylinder, and realizes multi-working-conditions hydraulic load simulation of an electro- hydrostatic actuator in an underwater high-pressure environment by adjusting the opening pressure of a proportional relief valve in the loading valve group, and by combined oil supply from the pressure compensators and the gear pump.

### CROSS-REFERENCE TO RELATED APPLICATION

This application claims the priority benefit of China application serial no. 202510495721.2, filed on Apr. 21, 2025. The entirety of the above-mentioned patent application is hereby incorporated by reference herein and made a part of this specification.

### BACKGROUND

### TECHNICAL FIELD

The present invention relates to an electro-hydrostatic actuator (EHA) loading method, belonging to the field of hydraulic technology, and in particular relates to a loading method for an underwater working conditions simulation test system for electro-hydrostatic actuators.

### DESCRIPTION OF RELATED ART

The underwater electro-hydrostatic actuator is the core unit for marine engineering equipment to achieve motion and complete operations. Its pressure resistance, sealing performance, working life, and motion performance under complex deep-sea working conditions are related to whether the marine engineering equipment can operate normally and stably. However, due to the high cost and long cycle of sea trials, it is difficult to truly conduct performance testing experiments in the marine environment, especially in the deep-sea environment. Therefore, it is necessary to design a simulation test platform to conduct full-working-conditions load simulation tests for underwater electro-hydrostatic actuators.

In the field of hydraulic transmission, when testing and verifying the response characteristics of the actuating mechanism of the tested device and the electro-hydrostatic control algorithm, it is necessary to simulate the actual working conditions of the tested equipment as much as possible, and simulate the load faced by the actuating mechanism through mechanical loading or hydraulic loading. In linear motion, hydraulic load simulation is mainly achieved through the combination of a loading hydraulic cylinder and a proportional relief valve, proportional throttle valve, or balancing valve. The load force is simulated by setting the valve opening to form a certain back pressure, and the set back pressure is controlled by an external electrical signal.

At present, existing high-pressure sealed cabins can only test the pressure resistance and sealing performance of the object being tested, and cannot complete load simulation tests for various working conditions of the electro-hydrostatic actuator in a pressure environment. Moreover, traditional actuator load simulation test platforms mostly use passive loading methods, meaning the loading cylinder cannot actively extend or retract, and cannot actively generate and apply loading force as load.

### SUMMARY

In order to solve the problems existing in the related art, the present invention proposes a loading method for an electro-hydrostatic actuator underwater working conditions simulation test system. The system and method of the present invention can realize the simulation of positive load and negative load conditions for electro-hydrostatic actuators in an underwater high-pressure environment.

The technical solution adopted by the present invention is:
I. The electro-hydrostatic actuator underwater working conditions simulation test system:
   The simulation test system includes oil source components, for oil power supply when the electro-hydrostatic actuator underwater working conditions simulation test system is testing in an underwater high-pressure environment;
   The simulation test system includes a safety valve group, connected to the oil source components as well as used for safety control when the underwater working conditions test system is testing in an underwater high-pressure environment;
   The simulation test system includes a loading valve group, connected to the oil source components and the safety valve group as well as used for active loading of the underwater working conditions test system by simulating different underwater load conditions in an underwater high-pressure environment;
   The simulation test system includes an actuating mechanism, connected to the loading valve group, and used for active loading by simulating different underwater load conditions under the adjustment of the oil source components and the loading valve group in an underwater high-pressure environment, so as to test the electro-hydrostatic actuator.

The underwater high-pressure environment is an underwater environment with ambient pressure higher than a preset water pressure.

The loading valve group includes a second check valve, a third check valve, a fourth check valve, a fifth check valve, a second pressure tap, a third pressure tap, a second pressure sensor, a third pressure sensor, a second relief valve, a third relief valve, a first proportional relief valve, a second proportional relief valve and an electromagnetic directional valve, a second oil inlet of the second check valve and a third oil inlet of the third check valve are both connected to the safety valve group, the oil circuit connecting a second oil outlet of the second check valve and the actuating mechanism is a second oil circuit b, and the oil circuit connecting a third oil outlet of the third check valve and the actuating mechanism is a third oil circuit c; a fifth oil inlet of the fifth check valve is connected to the second oil circuit b between the second oil outlet of the second check valve and an eleventh oil inlet of the electromagnetic directional valve, a fifth oil outlet of the fifth check valve, a tenth oil inlet of the second proportional relief valve and an eighth oil inlet of the third relief valve are connected in sequence, a fourth oil outlet of the fourth check valve, a ninth oil inlet of the first proportional relief valve and a seventh oil inlet of the second relief valve are connected in sequence, a seventh oil outlet of the second relief valve and an eighth oil outlet of the third relief valve are connected to the oil circuit leading to the safety valve group as the fourth oil circuit d, a fourth oil inlet of the fourth check valve is connected to the third oil circuit c between the third oil outlet of the third check valve and the eleventh oil inlet of the electromagnetic directional valve, the eleventh oil inlet and an eleventh oil outlet of the electromagnetic directional valve are connected to the second oil circuit b and the third oil circuit c respectively; the second pressure tap and the second pressure sensor are connected to the second oil circuit b, and the third pressure tap and the third pressure sensor are connected to the third oil circuit c; a second pressure compensator for second oil pressure compensation of the electro-hydrostatic actuator underwater working conditions simulation test system in a simulated underwater high-pressure environment is also threadedly connected to the loading valve group. The second pressure compensator is fixedly connected to the loading valve group via a flange plate threaded connection.

The safety valve group includes a first check valve, a pressure oil filter, a first relief valve, a first pressure tap and a first pressure sensor, a first oil inlet of the first check valve is connected to the oil source components, a first oil outlet of the first check valve is connected to a sixth oil inlet of the first relief valve via the pressure oil filter, the sixth oil inlet of the first relief valve is connected between the second oil inlet of the second check valve and the third oil inlet of the third check valve of the loading valve group, the oil circuit connecting a sixth oil outlet of the first relief valve and the oil source components is first oil circuit a, and the sixth oil outlet of the first relief valve is connected to the seventh oil outlet of the second relief valve of the loading valve group via the fourth oil circuit d; the first pressure tap and the first pressure sensor are connected at the sixth oil inlet of the first relief valve.

The oil source components includes an oil tank, a pressure-resistant temperature sensor, a suction filter, an oil-immersed motor and a gear pump, the oil-immersed motor is connected to the gear pump through a coupling, a suction port of the gear pump is connected to the oil tank via the suction filter, the pressure-resistant temperature sensor is located inside the oil tank; a twelfth oil outlet of the gear pump is connected to the first oil inlet of the first check valve of the safety valve group, the oil tank is connected to the sixth oil outlet of the first relief valve of the safety valve group via the first oil circuit a; a first pressure compensator for first oil pressure compensation of the electro-hydrostatic actuator underwater working conditions simulation test system in a simulated underwater high-pressure environment is also threadedly connected to the oil tank and the safety valve group.

The actuating mechanism includes a pressure-resistant displacement sensor, a loading hydraulic cylinder and a hinge mechanism, the loading hydraulic cylinder is a symmetrical cylinder, a first chamber A of the loading hydraulic cylinder is connected to the second oil outlet of the second check valve of the loading valve group via the second oil circuit b, a second chamber B of the loading hydraulic cylinder is connected to the third oil outlet of the third check valve of the loading valve group via the third oil circuit c, the pressure-resistant displacement sensor is installed at the end of a loading piston rod on the A-chamber side of the loading hydraulic cylinder, and the loading piston rod on the B-chamber side of the loading hydraulic cylinder is connected to a loaded piston rod of an execution hydraulic cylinder of tested underwater EHA through the hinge mechanism.

II. A loading method for the electro-hydrostatic actuator underwater working conditions simulation test system:

The electro-hydrostatic actuator underwater working conditions simulation test system first sets a first opening pressure of the first relief valve of the safety valve group to be higher than a preset maximum pressure of the electro-hydrostatic actuator underwater working conditions simulation test system to protect the normal operation of the hydraulic system; when the electro-hydrostatic actuator underwater working conditions simulation test system is not working, the electromagnetic directional valve is in a de-energized state, and the second oil circuit b and the third oil circuit c are connected; when the electro-hydrostatic actuator underwater working conditions simulation test system is performing testing work, the oil-immersed motor and the gear pump are in a working state, the electromagnetic directional valve is in an energized state, and the first chamber A and the second chamber B of the loading hydraulic cylinder are not connected; at this time, the electro-hydrostatic actuator underwater working conditions simulation test system is placed in a simulated underwater high-pressure environment inside a pressure vessel, wherein controllers for the first proportional relief valve, the second proportional relief valve, the electromagnetic directional valve and the oil-immersed motor are all placed outside the pressure vessel; during the test, the second oil circuit b and the third oil circuit c of the electro-hydrostatic actuator underwater working conditions simulation test system are disconnected, the gear pump draws oil from the oil tank through the suction filter, a high-pressure hydraulic oil with an outlet pressure higher than a preset threshold flows from the twelfth oil outlet of the gear pump through the first check valve and the pressure oil filter to the second check valve and the third check valve, the high-pressure hydraulic oil flows into the second oil circuit b and the third oil circuit c through the second check valve and the third check valve respectively, the fourth check valve and the fifth check valve are in an open state; by adjusting the oil source components, the loading valve group and the two pressure compensators, i.e., adjusting a fourth opening pressure of the first proportional relief valve and a fifth opening pressure of the second proportional relief valve, as well as the combination of the first pressure compensator, the second pressure compensator and the gear pump for oil supply, the active loading of four underwater load conditions is simulated, thereby testing the execution hydraulic cylinder of tested underwater EHA, the four underwater load conditions comprising two positive load conditions and two negative load conditions; and monitoring in real time an oil temperature, oil circuit pressure of the electro-hydrostatic actuator underwater working conditions simulation test system and a loading piston rod displacement of the loading hydraulic cylinder through the pressure-resistant temperature sensor, the three pressure sensors and the pressure-resistant displacement sensor; when the electro-hydrostatic actuator underwater working conditions simulation test system is monitored during the test that the oil temperature exceeds a preset temperature, an oil circuit pressure exceeds a preset pressure, or the loading piston rod displacement of the loading hydraulic cylinder exceeds a preset displacement range, then the controller closes the oil-immersed motor and places the electromagnetic directional valve in the de-energized state, to ensure system safety.

When the underwater working condition is set to a first positive load condition, the condition simulation is completed through the gear pump and the second proportional relief valve that adjusts a first cylinder pressure of the first chamber A of the loading hydraulic cylinder; the first chamber A of the loading hydraulic cylinder is a control chamber, a second oil circuit pressure in the third oil circuit c is the sum of the fourth opening pressure of the first proportional relief valve and a second opening pressure of the second relief valve, a first magnitude of an input current signal in the first proportional relief valve is controlled to be constant to maintain the oil circuit pressure in the third oil circuit c constant, and a hydraulic oil after pressure reduction flows to the second chamber B of the loading hydraulic cylinder; a first oil circuit pressure in the second oil circuit b is the sum of the fifth opening pressure of the second proportional relief valve and a third opening pressure of the third relief valve, a second magnitude of the input current signal in the second proportional relief valve is controlled to adjust the fifth opening pressure of the second proportional relief valve, thereby reducing the first oil circuit pressure of a hydraulic oil in the second oil circuit b, and the hydraulic oil after pressure reduction flows to the first chamber A of the loading hydraulic cylinder; by changing the fifth opening pressure of the second proportional relief valve, the first cylinder pressure of the first chamber A of the loading hydraulic cylinder is controlled to be greater than the second chamber B, the loading hydraulic cylinder forms a rightward dynamic loading force, the loaded piston rod of the execution hydraulic cylinder of tested underwater EHA extends and applies the generated pushing force to the loading piston rod of the loading hydraulic cylinder through the hinge mechanism, at this time a loading direction of the dynamic loading force of the loading hydraulic cylinder is opposite to an execution direction of the active force of the execution hydraulic cylinder of tested underwater EHA, completing the load simulation of the first positive load condition.

When the underwater working condition is set to the second positive load condition, the condition simulation is completed through the gear pump and the first proportional relief valve that adjusts a second cylinder pressure of the second chamber B of the loading hydraulic cylinder; the second chamber B of the loading hydraulic cylinder is the control chamber, the first oil circuit pressure in the second oil circuit b is the sum of the fifth opening pressure of the second proportional relief valve and the third opening pressure of the third relief valve, the second magnitude of the input current signal in the second proportional relief valve is controlled to be constant to maintain the first oil circuit pressure in the second oil circuit b constant, and the hydraulic oil after pressure reduction flows to the first chamber A of the loading hydraulic cylinder; the second oil circuit pressure in the third oil circuit c is the sum of the fourth opening pressure of the first proportional relief valve and the second opening pressure of the second relief valve, the first magnitude of the input current signal in the first proportional relief valve is controlled to adjust the fourth opening pressure of the first proportional relief valve, thereby reducing the second oil circuit pressure of a hydraulic oil in the third oil circuit c, and the hydraulic oil after pressure reduction flows to the second chamber B of the loading hydraulic cylinder; by changing the fourth opening pressure of the first proportional relief valve, the second cylinder pressure of the second chamber B of the loading hydraulic cylinder is controlled to be greater than the first chamber A, the loading hydraulic cylinder forms a leftward dynamic loading force, the loaded piston rod of the execution hydraulic cylinder of tested underwater EHA retracts and applies the generated pulling force to the loading piston rod of the loading hydraulic cylinder through the hinge mechanism, at this time the loading direction of the dynamic loading force of the loading hydraulic cylinder is opposite to the execution direction of the active force of the execution hydraulic cylinder of tested underwater EHA, completing the load simulation of the second positive load condition.

When the underwater working condition is set to the first negative load condition, the condition simulation is completed through the gear pump and the first proportional relief valve that adjusts the second cylinder pressure of the second chamber B of the loading hydraulic cylinder; the second chamber B of the loading hydraulic cylinder is the control chamber, the first oil circuit pressure in the second oil circuit b is the sum of the fifth opening pressure of the second proportional relief valve and the third opening pressure of the third relief valve, the second magnitude of the input current signal in the second proportional relief valve is controlled to be constant to maintain the first oil circuit pressure in the second oil circuit b constant, and the hydraulic oil after pressure reduction flows to the first chamber A of the loading hydraulic cylinder; the second oil circuit pressure in the third oil circuit c is the sum of the fourth opening pressure of the first proportional relief valve and the second opening pressure of the second relief valve, the first magnitude of the input current signal in the first proportional relief valve is controlled to adjust the fourth opening pressure of the first proportional relief valve, thereby reducing the second oil circuit pressure of the hydraulic oil in the third oil circuit c, and the hydraulic oil after pressure reduction flows to the second chamber B of the loading hydraulic cylinder; by changing the fourth opening pressure of the first proportional relief valve, the second cylinder pressure of the second chamber B of the loading hydraulic cylinder is controlled to be greater than the first chamber A, the loading hydraulic cylinder forms a leftward dynamic loading force, the loaded piston rod of the execution hydraulic cylinder of tested underwater EHA extends and applies the generated pushing force to the loading piston rod of the loading hydraulic cylinder through the hinge mechanism, at this time the loading direction of the dynamic loading force of the loading hydraulic cylinder is the same as the execution direction of the active force of the execution hydraulic cylinder of tested underwater EHA, completing the load simulation of the first negative load condition.

When the underwater working condition is set to the second negative load condition, the condition simulation is completed through the gear pump and the second proportional relief valve that adjusts the first cylinder pressure of the first chamber A of the loading cylinder; the first chamber A of the loading hydraulic cylinder is the control chamber, the second oil circuit pressure in the third oil circuit c is the sum of the fourth opening pressure of the first proportional relief valve and the second opening pressure of the second relief valve, the first magnitude of the input current signal in the first proportional relief valve is controlled to be constant to maintain the second oil circuit pressure in the third oil circuit c constant, and the hydraulic oil after pressure reduction flows to the second chamber B of the loading hydraulic cylinder; the first oil circuit pressure in the second oil circuit b is the sum of the fifth opening pressure of the second proportional relief valve and the third opening pressure of the third relief valve, the second magnitude of the input current signal in the second proportional relief valve is controlled to adjust the fifth opening pressure of the second proportional relief valve, thereby reducing the first oil circuit pressure of the hydraulic oil in the second oil circuit b, and the hydraulic oil after pressure reduction flows to the first chamber A of the loading hydraulic cylinder; by changing the fifth opening pressure of the second proportional relief valve, the first cylinder pressure of the first chamber A of the loading hydraulic cylinder is controlled to be greater than the second chamber B, the loading hydraulic cylinder forms a rightward dynamic loading force, the loaded piston rod of the execution hydraulic cylinder of tested underwater EHA retracts and applies the generated pulling force to the loading piston rod of the loading hydraulic cylinder through the hinge mechanism, at this time the loading direction of the dynamic loading force of the loading hydraulic cylinder is the same as the execution direction of the active force of the execution hydraulic cylinder of tested underwater EHA, completing the load simulation of the second negative load condition.

The present invention is based on the electro-hydrostatic actuator underwater working conditions simulation test system mainly comprising the gear pump, pressure compensators, the loading valve group and the loading hydraulic cylinder. By adjusting the fourth opening pressure of the first proportional relief valve and the fifth opening pressure of the second proportional relief valve in the loading valve group, and by combined oil supply from pressure compensators and the gear pump, multi-working-conditions hydraulic load simulation of the electro-hydrostatic actuator in an underwater high-pressure environment can be achieved. The present invention adjusts the oil circuit pressure of the electro-hydrostatic actuator underwater working conditions simulation test system through the pressure compensators, achieving hydraulic circuit oil compensation in an underwater high-pressure environment; by controlling the active extension and active retraction of the loading piston rod of the loading hydraulic cylinder, the electro-hydrostatic actuator underwater working conditions simulation test system can achieve hydraulic load simulation for four conditions: the two positive load conditions and the two negative load conditions; status detection sensors are set to monitor the oil temperature of the system, pressure, and displacement of the loading piston rod of the loading hydraulic cylinder in real time. When the measured value of the pressure-resistant displacement sensor exceeds the set displacement range or the system temperature or pressure exceeds the set value, the controller closes the oil-immersed motor and places the electromagnetic directional valve in the de-energized state, ensuring the safety of the hydraulic system; through setting the relief valves and the proportional relief valves in series, high-precision control of the first cylinder pressure and the second cylinder pressure of the loading hydraulic cylinder is achieved, which in turn achieves high-precision loading force control of the loading hydraulic cylinder.

The beneficial effects of the present invention are:
1. Compared with traditional onshore hydraulic load simulation methods and hydraulic systems, the present invention adjusts the oil circuit pressure of the hydraulic load simulation test system through pressure compensators, achieving hydraulic load simulation in an underwater high-pressure environment.
2. The present invention, by controlling the active extension and active retraction of the loading piston rod of the loading hydraulic cylinder, and the control chamber pressure for active extension and active retraction being adjustable by the proportional relief valves, can simulate four conditions: the first positive load condition, second positive load condition, first negative load condition, and second negative load condition.
3. The present invention sets status detection sensors, which can monitor the oil temperature of the system, pressure, and loading piston rod displacement in real time. When the measured value of the pressure-resistant displacement sensor exceeds the set displacement range or the system temperature or pressure exceeds the set value, the controller closes the oil-immersed motor and places the electromagnetic directional valve in the de-energized state, ensuring the safety of the hydraulic system.
4. The present invention, through setting the relief valves and the proportional relief valves in series, can achieve high-precision control of the first cylinder pressure and the second cylinder pressure of the loading hydraulic cylinder, and can achieve high-precision loading force control of the loading hydraulic cylinder.

### BRIEF DESCRIPTION OF THE DRAWINGS

FIG. 1 is a schematic diagram of an electro-hydrostatic actuator underwater working conditions simulation test system in accordance with the present invention;

FIG. 2 is an experimental result graph in accordance with the present invention simulating a negative load condition;

FIG. 3 is an experimental result graph in accordance with the present invention simulating a positive load condition;

FIG. 4 is an experimental result graph in accordance with the present invention simulating dynamic constant loading of positive and negative loads;

FIG. 5 is an experimental result graph in accordance with the present invention simulating dynamic alternating loading of positive and negative loads;

In the figures: 1, oil tank; 2, first pressure compensator; 3, pressure-resistant temperature sensor; 4, suction filter; 5, oil-immersed motor; 6, gear pump; 7.1, first check valve; 7.2, second check valve; 7.3, third check valve; 7.4, fourth check valve; 7.5, fifth check valve; 8, pressure oil filter; 9, first relief valve; 10.1, first pressure tap; 10.2, second pressure tap; 10.3, third pressure tap; 11.1, first pressure sensor; 11.2, second pressure sensor; 11.3, third pressure sensor; 12.1, second relief valve; 12.2, third relief valve; 13.1, first proportional relief valve; 13.2, second proportional relief valve; 14, electromagnetic directional valve; 15, pressure-resistant displacement sensor; 16, loading hydraulic cylinder; 17, execution hydraulic cylinder of tested underwater EHA; 18, second pressure compensator; 19, hinge mechanism; 20, oil source components; 21, safety valve group; 22, loading valve group;23, actuating mechanism; 24, electro-hydrostatic actuator underwater working conditions simulation test system; 25, pressure vessel.

### DESCRIPTION OF THE EMBODIMENTS

In order to make the objects, technical solutions, and advantages of the present invention clearer, the present invention is further described in detail below with reference to the accompanying drawings and embodiments. It should be understood that the specific embodiments described herein are only for explaining the present invention and not for limiting the present invention. In addition, the technical features involved in the various embodiments of the present invention described below can be combined with each other as long as they do not conflict with each other.

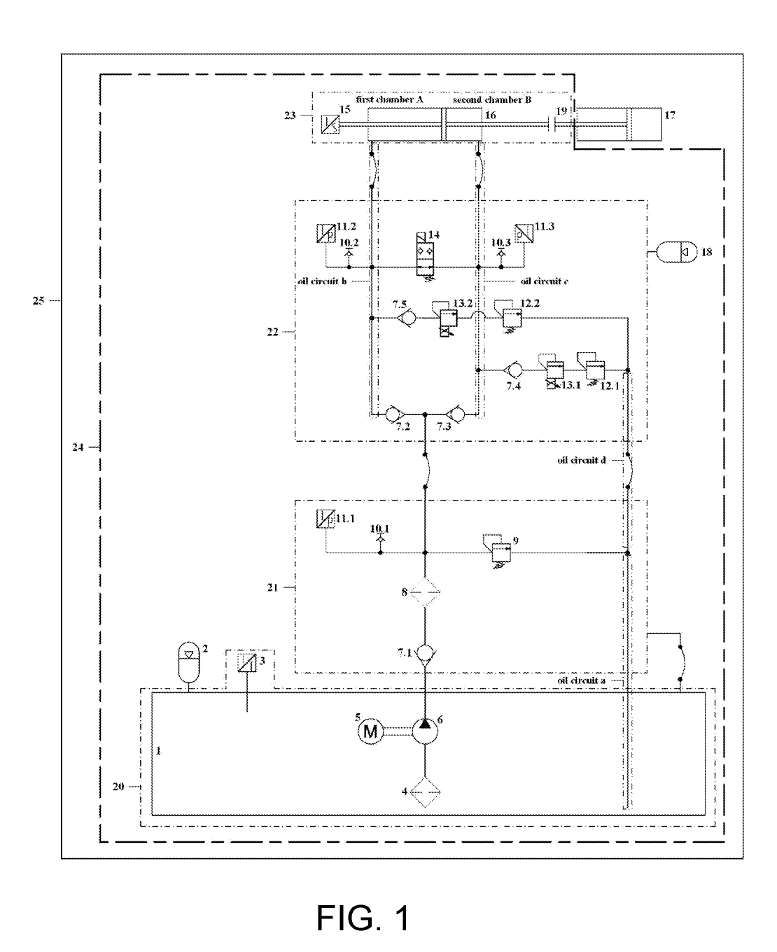

As shown in FIG. 1, an electro-hydrostatic actuator underwater working conditions simulation test system 24 of the present invention mainly comprises oil source components 20, a safety valve group 21, a loading valve group 22 and an actuating mechanism 23. The safety valve group 21 is connected to the oil source components 20, the loading valve group 22 is connected to the oil source components 20, the safety valve group 21 and the actuating mechanism 23. When the electro-hydrostatic actuator underwater working conditions simulation test system 24 is tested in an underwater high-pressure environment higher than a preset water pressure, oil power supply is provided through the oil source components 20, safety control is performed through the safety valve group 21, different underwater load conditions are simulated through the loading valve group 22 for active loading of the electro-hydrostatic actuator underwater working conditions simulation test system 24, and active loading simulating different underwater load conditions is performed through the actuating mechanism 23 under the adjustment of the oil source components 20 and the loading valve group 22, so as to test an electro-hydrostatic actuator. The oil source components 20 comprise an oil tank 1, a pressure-resistant temperature sensor 3, a suction filter 4, an oil-immersed motor 5 and a gear pump 6. The safety valve group 21 comprises a first check valve 7.1, a pressure oil filter 8, a first relief valve 9, a first pressure tap 10.1 and a first pressure sensor 11.1. The loading valve group 22 comprises a second check valve 7.2, a third check valve 7.3, a fourth check valve 7.4, a fifth check valve 7.5, a second pressure tap 10.2, a third pressure tap 10.3, a second pressure sensor 11.2, a third pressure sensor 11.3, a second relief valve 12.1, a third relief valve 12.2, a first proportional relief valve 13.1, a second proportional relief valve 13.2 and an electromagnetic directional valve 14. The actuating mechanism 23 comprises a pressure-resistant displacement sensor 15, a loading hydraulic cylinder 16 and a hinge mechanism 19.

The oil-immersed motor 5 of the oil source components 20 of the electro-hydrostatic actuator underwater working conditions simulation test system 24 is connected to the gear pump 6 through a coupling, a twelfth oil inlet of the gear pump 6 is connected to the oil tank 1 via the suction filter 4, and the pressure-resistant temperature sensor 3 is placed inside the oil tank 1; a twelfth oil outlet of the gear pump 6 is connected to a first oil inlet of the first check valve 7.1 of the safety valve group 21, the oil tank 1 is connected to a sixth oil outlet of the first relief valve 9 of the safety valve group 21 via the first oil circuit a; a first pressure compensator 2 for first oil pressure compensation of the electro-hydrostatic actuator underwater working conditions simulation test system 24 in a simulated underwater high-pressure environment is also threadedly connected to the oil tank 1 and the safety valve group 21.

The first oil inlet of the first check valve 7.1 of the safety valve group 21 of the electro-hydrostatic actuator underwater working conditions simulation test system 24 is connected to the twelfth oil outlet of the gear pump 6, a sixth oil inlet of the first relief valve 9 is connected to a first oil outlet of the first check valve 7.1 via the pressure oil filter 8, the sixth oil inlet of the first relief valve 9 is connected between a second oil inlet of the second check valve 7.2 and a third oil inlet of the third check valve 7.3 of the loading valve group 22, the oil circuit connecting the sixth oil outlet of the first relief valve 9 and the oil source components 20 is first oil circuit a, the sixth oil outlet of the first relief valve 9 is connected to the oil tank 1 via the first oil circuit a, the sixth oil outlet of the first relief valve 9 is connected to a seventh oil outlet of the second relief valve 12.1 of the loading valve group 22 via the fourth oil circuit d, a first opening pressure of the first relief valve 9 must be higher than a limited maximum oil circuit pressure of the system to protect the normal operation of the hydraulic system, the first pressure tap 10.1 and the first pressure sensor 11.1 are connected to the sixth oil inlet of the first relief valve 9. The first pressure compensator 2 is fixedly connected to the oil tank 1 and the safety valve group 21 via a flange plate threaded connection, realizing first oil pressure compensation for the oil source components 20 and the safety valve group 21 in a high-pressure environment.

The sixth oil inlet of the first relief valve 9 of the loading valve group 22 of the electro-hydrostatic actuator underwater working conditions simulation test system 24 is connected via two oil circuits to the second oil inlet of the second check valve 7.2 and the third oil inlet of the third check valve 7.3, respectively. A second oil outlet of the second check valve 7.2 is connected to a first chamber A of the loading hydraulic cylinder 16 via a second oil circuit b. The oil circuit connecting the second oil outlet of the second check valve 7.2 and the actuating mechanism 23 is the second oil circuit b. The oil circuit connecting a third oil outlet of the third check valve 7.3 and the actuating mechanism 23 is a third oil circuit c. A fifth oil inlet of the fifth check valve 7.5 is connected to the second oil circuit b between the second oil outlet of the second check valve 7.2 and an eleventh oil inlet of the electromagnetic directional valve 14. A tenth oil inlet of the second proportional relief valve 13.2 is connected to a fifth oil outlet of the fifth check valve 7.5. An eighth oil inlet of the third relief valve 12.2 is connected to a tenth oil outlet of the second proportional relief valve 13.2. The third oil outlet of the third check valve 7.3 is connected to a second chamber B of the loading hydraulic cylinder 16 via the third oil circuit c. A fourth oil inlet of the fourth check valve 7.4 is connected to the third oil circuit c between the third oil outlet of the third check valve 7.3 and the eleventh oil inlet of the electromagnetic directional valve 14. A ninth oil inlet of the first proportional relief valve 13.1 is connected to a fourth oil outlet of the fourth check valve 7.4. A seventh oil inlet of the second relief valve 12.1 is connected to a ninth oil outlet of the first proportional relief valve 13.1. The seventh oil outlet of the second relief valve 12.1 and an eighth oil outlet of the third relief valve 12.2 are connected to the oil circuit leading to the safety valve group 21 as the fourth oil circuit d. The seventh oil outlet of the second relief valve 12.1 and the eighth oil outlet of the third relief valve 12.2 are connected, and are directly connected to the sixth oil outlet of the first relief valve 9 via the fourth oil circuit d. The eleventh oil inlet and an eleventh oil outlet of the electromagnetic directional valve 14 are connected to the second oil circuit b and the third oil circuit c, respectively. The second pressure tap 10.2 and the second pressure sensor 11.2 are connected to the second oil circuit b. The third pressure tap 10.3 and the third pressure sensor 11.3 are connected to the third oil circuit c. A second pressure compensator 18 is fixedly connected to the loading valve group 22 via a flange plate threaded connection, realizing second oil pressure compensation for the loading valve group 22 in a high-pressure environment.

The first pressure compensator 2 and the second pressure compensator 18 are both compensation diaphragm pressure compensators, which have two functions: ambient pressure compensation and dynamic pressure compensation. Ambient pressure compensation means the pressure compensator compensates for the change in hydraulic oil volume caused by changes in ambient pressure. Dynamic pressure compensation means the pressure compensator dynamically compensates the oil circuit pressure of the hydraulic system under a certain ambient pressure. When the hydraulic system is placed in a high-pressure sealed cabin to simulate a deep-sea high-water-pressure environment, the internal compensation diaphragm of the pressure compensator moves due to a hydraulic system pressure and the ambient pressure, until the compensation diaphragm balances and stops moving under the action of hydraulic oil and seawater pressure. At this time, the hydraulic oil volume compression caused by the high-pressure environment and the suction cavitation caused by system operation are compensated.

In another embodiment of the present invention, the series-connected first proportional relief valve 13.1 and the second relief valve 12.1 can be replaced by a single proportional relief valve, and the series-connected second proportional relief valve 13.2 and third relief valve 12.2 can be replaced by a single proportional relief valve.

The loading hydraulic cylinder 16 of the actuating mechanism 23 of the electro-hydrostatic actuator underwater working conditions simulation test system 24 is a symmetrical cylinder. The first chamber A of the loading hydraulic cylinder 16 is connected to the second oil outlet of the second check valve 7.2 of the loading valve group 22 via the second oil circuit b. The second chamber B of the loading hydraulic cylinder 16 is connected to the third oil outlet of the third check valve 7.3 of the loading valve group 22 via the third oil circuit c. The external pressure-resistant displacement sensor 15 is installed at the end of a loading piston rod on the A-chamber side of the loading hydraulic cylinder 16. The loading piston rod on the B-chamber side is connected to a loaded piston rod of an execution hydraulic cylinder of tested underwater EHA 17 through the hinge mechanism 19.

The electro-hydrostatic actuator underwater working conditions simulation test system 24 and loading method of the present invention can achieve the active load simulation of four conditions: two positive load conditions and two negative load conditions. 1) A first positive load condition: the loaded piston rod of the execution hydraulic cylinder of tested underwater EHA 17 extends, i.e., the active force generated by the execution hydraulic cylinder of tested underwater EHA 17 is a pushing force, and the loading hydraulic cylinder 16 is required to apply a load force in the opposite direction to the movement of the loaded piston rod of the execution hydraulic cylinder of tested underwater EHA 17. 2) Second positive load condition: the loaded piston rod of the execution hydraulic cylinder of tested underwater EHA 17 retracts, i.e., the active force generated by the execution hydraulic cylinder of tested underwater EHA 17 is a pulling force, and the loading hydraulic cylinder 16 is required to apply a load force in the opposite direction to the movement of the loaded piston rod of the execution hydraulic cylinder of tested underwater EHA 17. 3) First negative load condition: the loaded piston rod of the execution hydraulic cylinder of tested underwater EHA 17 extends, i.e., the active force generated by the execution hydraulic cylinder of tested underwater EHA 17 is a pushing force, and the loading hydraulic cylinder 16 is required to apply a load force in the same direction as the movement of the loaded piston rod of the execution hydraulic cylinder of tested underwater EHA 17. 4) Second negative load condition: the loaded piston rod of the execution hydraulic cylinder of tested underwater EHA 17 retracts, i.e., the active force generated by the execution hydraulic cylinder of tested underwater EHA 17 is a pulling force, and the loading hydraulic cylinder 16 is required to apply a load force in the same direction as the movement of the loaded piston rod of the execution hydraulic cylinder of tested underwater EHA 17.

The loading method of the electro-hydrostatic actuator underwater working conditions simulation test system 24 in the specific implementation of the present invention is as follows:

Except for controllers of the first proportional relief valve 13.1, the second proportional relief valve 13.2, the electromagnetic directional valve 14, and the oil-immersed motor 5, all components of the electro-hydrostatic actuator underwater working conditions simulation test system 24 are placed inside a pressure vessel 25 to simulate an underwater high-pressure environment, and a system pressure compensation is achieved through the first pressure compensator 2 and the second pressure compensator 18. The pressure-resistant temperature sensor 3 monitors an oil temperature of the oil tank 1 in real time. The first pressure sensor 11.1 monitors an inlet pressure of the loading valve group 22 in real time. The second pressure sensor 11.2 monitors a first oil circuit pressure of the second oil circuit b and a first cylinder pressure of the first chamber A of the loading hydraulic cylinder 16 in real time. The third pressure sensor 11.3 monitors a second oil circuit pressure of the third oil circuit c and a second cylinder pressure of the second chamber B of the loading hydraulic cylinder 16 in real time. The pressure-resistant displacement sensor 15 monitors a loading piston rod displacement of the loading hydraulic cylinder 16 in real time. When the measured value of the pressure-resistant temperature sensor 3 exceeds the set upper temperature limit, the measured values of the three pressure sensors 11.1, 11.2, 11.3 exceed the set upper pressure limit, or the measured value of the pressure-resistant displacement sensor 15 exceeds the set displacement range, the controller closes the oil-immersed motor 5 and places the electromagnetic directional valve 14 in a de-energized state to stop the electro-hydrostatic actuator underwater working conditions simulation test system 24.

By adjusting an input current signal of the electromagnetic directional valve 14, the connection and disconnection between the second oil circuit b and the third oil circuit c can be controlled. Increasing the input current signal puts the electromagnetic directional valve 14 in an energized state, disconnecting the second oil circuit b and the third oil circuit c to start the underwater working conditions simulation test. Decreasing the input current signal puts the electromagnetic directional valve 14 in the de-energized state, connecting the second oil circuit b and the third oil circuit c to quickly balance the pressure in the two chambers of the loading hydraulic cylinder 16, thereby stopping the underwater working conditions simulation test. When the electro-hydrostatic actuator underwater working conditions simulation test system 24 is working, the pressure-resistant temperature sensor 3, the three pressure sensors 11.1, 11.2, 11.3, and the pressure-resistant displacement sensor 15 remain working at all times. A preset second opening pressure of the second relief valve 12.1 and a preset third opening pressure of the third relief valve 12.2 remain unchanged. By adjusting a fourth opening pressure of the first proportional relief valve 13.1 and a fifth opening pressure of the second proportional relief valve 13.2 through the controller, and the combined oil supply from the two pressure compensators 2, 18 and the gear pump 6, active loading for hydraulic load simulation in an underwater high-pressure environment can be achieved.

When the electro-hydrostatic actuator underwater working conditions simulation test system 24 is working, first, the first opening pressure of the first relief valve 9 of the safety valve group 21 is set to be higher than a preset maximum pressure of the electro-hydrostatic actuator underwater working conditions simulation test system 24 to protect the normal operation of the hydraulic system; when the electro-hydrostatic actuator underwater working conditions simulation test system 24 is not working, the electromagnetic directional valve 14 is in the de-energized state, and the second oil circuit b and the third oil circuit c are connected; when the electro-hydrostatic actuator underwater working conditions simulation test system 24 is performing testing work, the oil-immersed motor 5 and the gear pump 6 are in a working state, the electromagnetic directional valve 14 is in the energized state, and the first chamber A and the second chamber B of the loading hydraulic cylinder 16 are not connected; at this time, the electro-hydrostatic actuator underwater working conditions simulation test system 24 is placed in a simulated underwater high-pressure environment inside the pressure vessel 25. The controllers of the first proportional relief valve 13.1, the second proportional relief valve 13.2, the electromagnetic directional valve 14 and the oil-immersed motor 5 are all located outside the pressure vessel 25. During the test, the second oil circuit b and the third oil circuit c of the electro-hydrostatic actuator underwater working conditions simulation test system 24 are disconnected, the gear pump 6 draws oil from the oil tank 1 through the suction filter 4, a high-pressure hydraulic oil with an outlet pressure higher than a preset threshold flows from the twelfth oil outlet of the gear pump 6 through the first check valve 7.1 and the pressure oil filter 8 to the second check valve 7.2 and the third check valve 7.3, the high-pressure hydraulic oil flows into the second oil circuit b and the third oil circuit c through the second check valve 7.2 and the third check valve 7.3 respectively, the fourth check valve 7.4 and the fifth check valve 7.5 are in an open state; by adjusting the oil source components 20, the loading valve group 22 and the two pressure compensators 2, 18, i.e., adjusting the fourth opening pressure of the first proportional relief valve 13.1 and the fifth opening pressure of the second proportional relief valve 13.2, as well as the combination of the first pressure compensator 2, the second pressure compensator 18 and the gear pump 6 for oil supply, the active loading of four underwater load conditions is simulated, thereby testing the execution hydraulic cylinder of tested underwater EHA 17, the four underwater load conditions comprising the two positive load conditions and the two negative load conditions; and monitoring in real time the oil temperature, oil circuit pressure of the electro-hydrostatic actuator underwater working conditions simulation test system 24 and the loading piston rod displacement of the loading hydraulic cylinder 16 through the pressure-resistant temperature sensor 3, the three pressure sensors 11.1, 11.2, 11.3 and the pressure-resistant displacement sensor 15; when the electro-hydrostatic actuator underwater working conditions simulation test system is monitored during the test that the oil temperature exceeds a preset temperature, an oil circuit pressure exceeds a preset pressure, or the loading piston rod displacement of the loading hydraulic cylinder 16 exceeds a preset displacement range, then the controller closes the oil-immersed motor 5 and places the electromagnetic directional valve 14 in the de-energized state, to ensure system safety.

The specific load conditions of the electro-hydrostatic actuator underwater working conditions simulation test system 24 are as follows:

1) The first positive load condition:

When the loaded piston rod of the execution hydraulic cylinder of tested underwater EHA 17 extends, acting on the loading piston rod of the loading hydraulic cylinder 16 through the hinge mechanism 19 and applying a pushing force to it, the loading hydraulic cylinder 16 provides a loading force in the opposite direction to an execution direction of the execution hydraulic cylinder of tested underwater EHA 17. At this time, the first positive load condition can be simulated, achieved by the gear pump 6 and the second proportional relief valve 13.2 which adjusts the first cylinder pressure of the first chamber A of the loading hydraulic cylinder 16; the first chamber A of the loading hydraulic cylinder 16 is a control chamber. Specifically, the oil-immersed motor 5 works, the gear pump 6 is in an open state, the first relief valve 9 is used as a safety valve, the first opening pressure of the first relief valve 9 is set higher than the preset maximum pressure of the system, and the electromagnetic directional valve 14 is in the energized state. The gear pump 6 draws oil from the oil tank 1 through the suction filter 4, the high-pressure oil from the pump outlet flows through the first check valve 7.1 and the pressure oil filter 8 to the second check valve 7.2 and the third check valve 7.3. The high-pressure oil flows into the second oil circuit b via the second check valve 7.2 and into the third oil circuit c via the third check valve 7.3. At this time, the first proportional relief valve 13.1, the second relief valve 12.1, the second proportional relief valve 13.2, and the third relief valve 12.2 are all in an overflow state. The second oil circuit pressure in the third oil circuit c is the sum of the fourth opening pressure of the first proportional relief valve 13.1 and a second opening pressure of the second relief valve 12.1. By controlling a first magnitude of the input current signal in the first proportional relief valve 13.1 to be constant, the second oil circuit pressure in the third oil circuit c can be maintained constant, and the pressure-reduced oil flows to the second chamber B of the loading hydraulic cylinder 16. The first oil circuit pressure in the second oil circuit b is the sum of the fifth opening pressure of the second proportional relief valve 13.2 and the third opening pressure of the third relief valve 12.2. By adjusting a second magnitude of the input current signal in the second proportional relief valve 13.2, the fifth opening pressure of the second proportional relief valve 13.2 can be adjusted, thereby adjusting the second oil circuit pressure in the second oil circuit b, and the pressure-reduced oil flows to the first chamber A of the loading hydraulic cylinder 16. By changing the fifth opening pressure of the second proportional relief valve 13.2, the pressure in the first chamber A is controlled to be greater than that in the second chamber B, causing the loading hydraulic cylinder 16 to form a rightward dynamic loading force, thus achieving dynamic loading of the loading hydraulic cylinder 16. It should be noted that if the pressure difference between chambers A and B is greater than the active force of the execution hydraulic cylinder of tested underwater EHA 17, the piston of the loading hydraulic cylinder 16 moves to the right, and the execution hydraulic cylinder of tested underwater EHA 17 is forced to retract; if the pressure difference between chambers A and B is less than the active force of the execution hydraulic cylinder of tested underwater EHA 17, the piston of the loading hydraulic cylinder 16 is forced to move to the left. At this time, to prevent suction cavitation in the second chamber B, the gear pump 6 supplies replenishing oil to the second chamber B of the loading hydraulic cylinder 16 through the third oil circuit c.

2) Second positive load condition:

When the loaded piston rod of the execution hydraulic cylinder of tested underwater EHA 17 retracts, acting on the loading piston rod of the loading hydraulic cylinder 16 through the hinge mechanism 19 and applying a pulling force to it, the loading hydraulic cylinder 16 provides a loading force in the opposite direction to the execution direction of the execution hydraulic cylinder of tested underwater EHA 17. At this time, the second positive load condition can be simulated, achieved by the gear pump 6 and the first proportional relief valve 13.1 which adjusts the second cylinder pressure of the second chamber B of the loading hydraulic cylinder 16; the second chamber B of the loading hydraulic cylinder 16 is the control chamber. Specifically, the oil-immersed motor 5 works, the gear pump 6 is in an open state, the first relief valve 9 is used as a safety valve, the first opening pressure of the first relief valve 9 is set higher than the preset maximum pressure of the system, and the electromagnetic directional valve 14 is in the energized state. The gear pump 6 draws oil from the oil tank 1 through the suction filter 4, the high-pressure oil from the pump outlet flows through the first check valve 7.1 and the pressure oil filter 8 to the second check valve 7.2 and the third check valve 7.3. The high-pressure oil flows into the second oil circuit b via the second check valve 7.2 and into the third oil circuit c via the third check valve 7.3. At this time, the first proportional relief valve 13.1, the second relief valve 12.1, the second proportional relief valve 13.2, and the third relief valve 12.2 are all in an overflow state. The first oil circuit pressure in the second oil circuit b is the sum of the fifth opening pressure of the second proportional relief valve 13.2 and the third opening pressure of the third relief valve 12.2. By controlling the second magnitude of the input current signal in the second proportional relief valve 13.2 to be constant, the first oil circuit pressure in the second oil circuit b can be maintained constant, and the pressure-reduced oil flows to the first chamber A of the loading hydraulic cylinder 16. The second oil circuit pressure in the third oil circuit c is the sum of the fourth opening pressure of the first proportional relief valve 13.1 and the second opening pressure of the second relief valve 12.1. By adjusting the first magnitude of the input current signal in the first proportional relief valve 13.1, the fourth opening pressure of the first proportional relief valve 13.1 can be adjusted, thereby adjusting the second oil circuit pressure in the third oil circuit c, and the pressure-reduced oil flows to the second chamber B of the loading hydraulic cylinder 16. By changing the fourth opening pressure of the first proportional relief valve 13.1, the pressure in the second chamber B is controlled to be greater than that in the first chamber A, causing the loading hydraulic cylinder 16 to form a leftward dynamic loading force, thus achieving dynamic loading of the loading hydraulic cylinder 16. It should be noted that if the pressure difference between chambers A and B is greater than the active force of the execution hydraulic cylinder of tested underwater EHA 17, the piston of the loading hydraulic cylinder 16 moves to the left, and the execution hydraulic cylinder of tested underwater EHA 17 is forced to extend; if the pressure difference between chambers A and B is less than the active force of the execution hydraulic cylinder of tested underwater EHA 17, the piston of the loading hydraulic cylinder 16 is forced to move to the right. At this time, to prevent suction cavitation in the first chamber A, the gear pump 6 supplies replenishing oil to the first chamber A of the loading hydraulic cylinder 16 through the second oil circuit b.

3) First negative load condition:

When the loaded piston rod of the execution hydraulic cylinder of tested underwater EHA 17 extends, acting on the loading piston rod of the loading cylinder 16 through the hinge mechanism 19 and applying a pushing force to it, the loading cylinder 16 provides a loading force in the same direction as the execution direction of the execution hydraulic cylinder of tested underwater EHA 17. At this time, the first negative load condition can be simulated, achieved by the gear pump 6 and the first proportional relief valve 13.1 which adjusts the second cylinder pressure of the second chamber B of the loading hydraulic cylinder 16; the second chamber B of the loading hydraulic cylinder 16 is the control chamber. Specifically, the oil-immersed motor 5 works, the gear pump 6 is in an open state, the first relief valve 9 is used as a safety valve, the first opening pressure of the first relief valve 9 is set higher than the preset maximum pressure of the system, and the electromagnetic directional valve 14 is in the energized state. The gear pump 6 draws oil from the oil tank 1 through the suction filter 4, the high-pressure oil from the pump outlet flows through the first check valve 7.1 and the pressure oil filter 8 to the second check valve 7.2 and the third check valve 7.3. The high-pressure oil flows into the second oil circuit b via the second check valve 7.2 and into the third oil circuit c via the third check valve 7.3. At this time, the first proportional relief valve 13.1, the second relief valve 12.1, the second proportional relief valve 13.2, and the third relief valve 12.2 are all in an overflow state. The first oil circuit pressure in the second oil circuit b is the sum of the fifth opening pressure of the second proportional relief valve 13.2 and the third opening pressure of the third relief valve 12.2. By controlling the second magnitude of the input current signal in the second proportional relief valve 13.2 to be constant, the first oil circuit pressure in the second oil circuit b can be maintained constant, and the pressure-reduced oil flows to the first chamber A of the loading hydraulic cylinder 16. The second oil circuit pressure in the third oil circuit c is the sum of the fourth opening pressure of the first proportional relief valve 13.1 and the second opening pressure of the second relief valve 12.1. By adjusting the first magnitude of the input current signal in the first proportional relief valve 13.1, the fourth opening pressure of the first proportional relief valve 13.1 can be adjusted, thereby adjusting the second oil circuit pressure in the third oil circuit c, and the pressure-reduced oil flows to the second chamber B of the loading hydraulic cylinder 16. By changing the fourth opening pressure of the first proportional relief valve 13.1, the pressure in the second chamber B is controlled to be greater than that in the first chamber A, causing the loading hydraulic cylinder 16 to form a leftward dynamic loading force, thus achieving dynamic loading of the loading hydraulic cylinder 16. It should be noted that the execution direction of the active force generated by the execution hydraulic cylinder of tested underwater EHA 17 is the same as a loading direction of the loading force provided by the loading hydraulic cylinder 16, which will cause the loading piston rod of the loading hydraulic cylinder 16 to move rapidly to the left. To prevent suction cavitation in the second chamber B due to the rapid piston movement of the loading hydraulic cylinder 16, the gear pump 6 supplies replenishing oil to the second chamber B of the loading hydraulic cylinder 16 through the third oil circuit c.

4) Second negative load condition:

When the loaded piston rod of the execution hydraulic cylinder of tested underwater EHA 17 retracts, acting on the loading piston rod of the loading hydraulic cylinder 16 through the hinge mechanism 19 and applying a pulling force to it, the loading hydraulic cylinder 16 provides a loading force in the same direction as the execution direction of the execution hydraulic cylinder of tested underwater EHA 17. At this time, the second negative load condition can be simulated, achieved by the gear pump 6 and the second proportional relief valve 13.2 which adjusts the first cylinder pressure of the first chamber A of the loading hydraulic cylinder 16; the first chamber A of the loading hydraulic cylinder 16 is the control chamber. Specifically, the oil-immersed motor 5 works, the gear pump 6 is in an open state, the first relief valve 9 is used as a safety valve, the first opening pressure of the first relief valve 9 is set higher than the preset maximum pressure of the system, and the electromagnetic directional valve 14 is in the energized state. The gear pump 6 draws oil from the oil tank 1 through the suction filter 4, the high-pressure oil from the pump outlet flows through the first check valve 7.1 and the pressure oil filter 8 to the second check valve 7.2 and the third check valve 7.3. The high-pressure oil flows into the second oil circuit b via the second check valve 7.2 and into the third oil circuit c via the third check valve 7.3. At this time, the first proportional relief valve 13.1, the second relief valve 12.1, the second proportional relief valve 13.2, and the third relief valve 12.2 are all in an overflow state. The second oil circuit pressure in the third oil circuit c is the sum of the fourth opening pressure of the first proportional relief valve 13.1 and the second opening pressure of the second relief valve 12.1. By controlling the first magnitude of the input current signal in the first proportional relief valve 13.1 to be constant, the second oil circuit pressure in the third oil circuit c can be maintained constant, and the pressure-reduced oil flows to the second chamber B of the loading hydraulic cylinder 16. The first oil circuit pressure in the second oil circuit b is the sum of the fifth opening pressure of the second proportional relief valve 13.2 and the third opening pressure of the third relief valve 12.2. By adjusting the second magnitude of the input current signal in the second proportional relief valve 13.2, the fifth opening pressure of the second proportional relief valve 13.2 can be adjusted, thereby adjusting the first oil circuit pressure in the second oil circuit b, and the pressure-reduced oil flows to the first chamber A of the loading hydraulic cylinder 16. By changing the fifth opening pressure of the second proportional relief valve 13.2, the pressure in the first chamber A is controlled to be greater than that in the second chamber B, causing the loading hydraulic cylinder 16 to form a rightward dynamic loading force, thus achieving dynamic loading of the loading hydraulic cylinder 16. It should be noted that the execution direction of the active force generated by the execution hydraulic cylinder of tested underwater EHA 17 is the same as the loading direction of the loading force provided by the loading hydraulic cylinder 16, which will cause the piston of the loading hydraulic cylinder 16 to move rapidly to the right. To prevent suction cavitation in the first chamber A due to the rapid piston movement of the loading hydraulic cylinder 16, the gear pump 6 supplies replenishing oil to the first chamber A of the loading hydraulic cylinder 16 through the second oil circuit b.

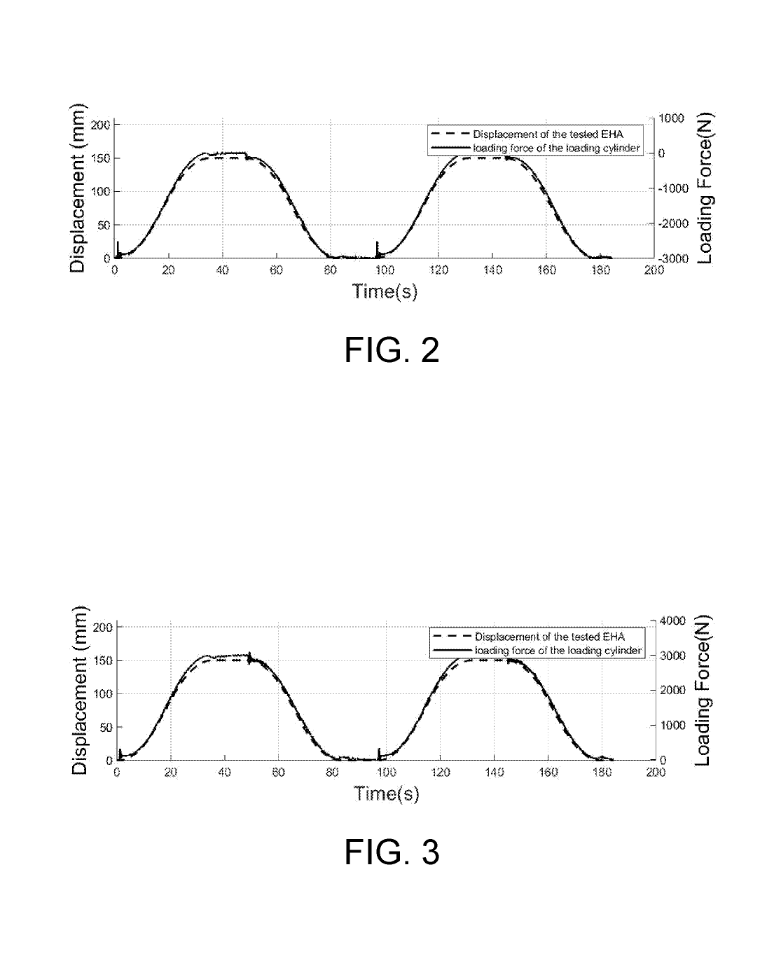

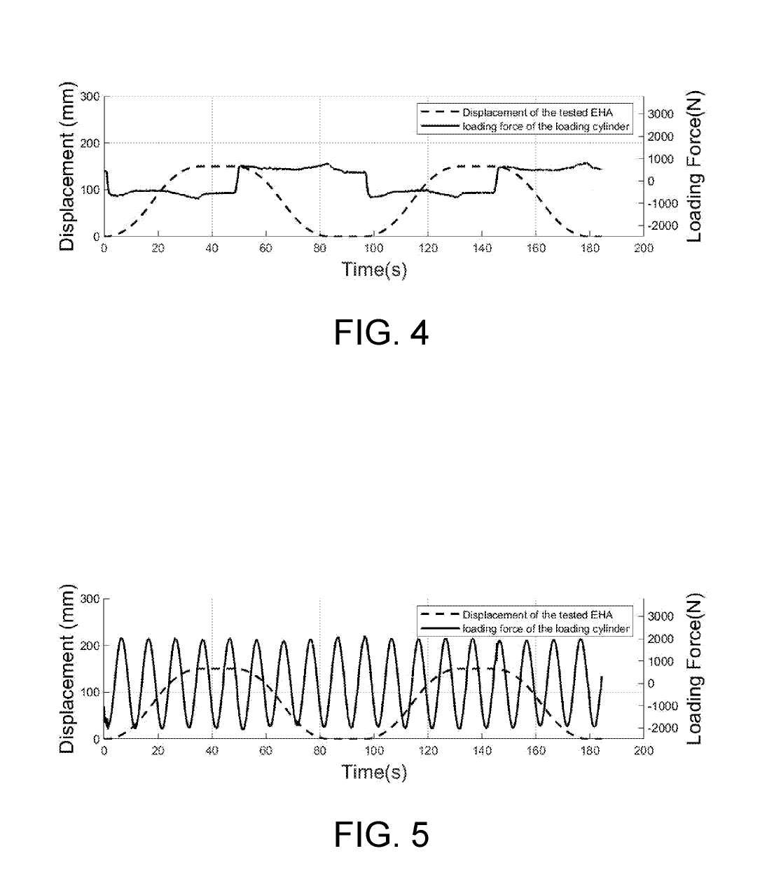

In the specific implementation of the present invention, the pressure vessel 25 is used to simulate the deep-sea environment, and a dynamic load is applied to the execution hydraulic cylinder of tested underwater EHA 17 under onshore conditions. The internal environment of the pressure vessel 25 is set to simulate a deep-sea environment at a water depth of 3000 meters, with an ambient pressure of 30MPa and a temperature of 4°C. As shown in FIG. 2 and FIG. 3, the execution hydraulic cylinder of tested underwater EHA 17 follows a preset trajectory, with a preset displacement of 0~150mm. The loading hydraulic cylinder 16 can apply dynamically changing negative loading force and positive loading force to the execution hydraulic cylinder of tested underwater EHA 17. The negative loading range is -3000N~0N, and the positive loading range is 0N~3000N. As shown in FIG. 4, the execution hydraulic cylinder of tested underwater EHA 17 follows a preset trajectory, with a preset displacement of 0~150mm. The loading hydraulic cylinder 16 can simulate constant positive load and negative load conditions for the execution hydraulic cylinder of tested underwater EHA 17. The positive load is 600N, and the negative load is -600N, and the electro-hydrostatic actuator underwater working conditions simulation test system can switch quickly between positive and negative load conditions, with a switching time of about 1.5 seconds. As shown in FIG. 5, the execution hydraulic cylinder of tested underwater EHA 17 follows a preset trajectory, with a preset displacement of 0~150mm. The loading hydraulic cylinder 16 can simulate alternating positive load and negative load conditions for the execution hydraulic cylinder of tested underwater EHA 17, with an alternating frequency of 0.1Hz, a positive load peak of 2000N, and a negative load peak of -2000N. It can be seen that the present invention can simulate the underwater working conditions of the underwater EHA onshore, and apply dynamic loads to the execution hydraulic cylinder of tested underwater EHA 17, thereby verifying the underwater working performance of the underwater EHA.

When the present invention implements high-precision loading force control, the first proportional relief valve 13.1 and the second relief valve 12.1 are connected in series and then connected to the third oil circuit c via the fourth check valve, to achieve pressure control of the second chamber B of the loading hydraulic cylinder 16. The second proportional relief valve 13.2 and the third relief valve 12.2 are connected in series and then connected to the second oil circuit b via the fifth check valve, to achieve pressure control of the first chamber A of the loading hydraulic cylinder 16. The second relief valve 12.1 and the third relief valve 12.2 achieve large-range second opening pressure and third opening pressure adjustment, completing low-precision adjustment of the system pressure. The first proportional relief valve 13.1 and the second proportional relief valve 13.2 achieve small-range fourth opening pressure and fifth opening pressure adjustment, completing online high-precision adjustment of the system pressure by controlling the input current signal. Furthermore, through high-precision system pressure adjustment, high-precision loading force control of the loading hydraulic cylinder 16 is achieved.

The above is only one embodiment of the present invention and cannot be used to limit the present invention. Therefore, equivalent changes made within the scope of the present invention still fall within the protection scope of the present invention.

What is claimed is:

1. A loading method for an electro-hydrostatic actuator underwater working conditions simulation test system, wherein the electro-hydrostatic actuator underwater working conditions simulation test system comprising:
oil source components, a safety valve group, a loading valve group and an actuating mechanism, the oil source components are used for oil power supply when the electro-hydrostatic actuator underwater working conditions simulation test system is working in an underwater environment; the safety valve group is connected to the oil source components and used for safety control when the electro-hydrostatic actuator underwater working conditions simulation test system is working in the underwater environment; the loading valve group is connected to the oil source components and the safety valve group, and used for active loading of the electro-hydrostatic actuator underwater working conditions simulation test system by simulating different underwater load conditions in the underwater environment; the actuating mechanism is connected to the loading valve group and used for active loading simulating different underwater load conditions under the adjustment of the oil source components and the loading valve group in the underwater environment, so as to test an electro-hydrostatic actuator; a first proportional relief valve and a second relief valve of the loading valve group are in series, a second proportional relief valve and a third relief valve are in series, and a second pressure compensator for second oil pressure compensation of the electro-hydrostatic actuator underwater working conditions simulation test system in a simulated underwater environment is threadedly connected to the loading valve group; a first pressure compensator for first oil pressure compensation of the electro-hydrostatic actuator underwater working conditions simulation test system in the simulated underwater environment is threadedly connected to an oil tank of the oil source components and the safety valve group; a loading hydraulic cylinder of the actuating mechanism is a symmetrical cylinder, comprises: the underwater working condition simulation test system first setting a first opening pressure of a first relief valve of the safety valve group to be higher than a preset maximum pressure of the electro-hydrostatic actuator underwater working conditions simulation test system; when the electro-hydrostatic actuator underwater working conditions simulation test system is not working, an electromagnetic directional valve is in a de-energized state, and a second oil circuit and a third oil circuit are connected, when the underwater working condition simulation test system is performing testing work, an oil-immersed motor and a gear pump are in a working state, the electromagnetic directional valve is in an energized state, and a first chamber and a second chamber of the loading hydraulic cylinder are not connected; at this time, the electro-hydrostatic actuator underwater working conditions simulation test system is placed in the simulated underwater environment inside a pressure vessel, wherein controllers for the first proportional relief valve, the second proportional relief valve, the electromagnetic directional valve and the oil-immersed motor are all located outside the pressure vessel, during the test, the second oil circuit and the third oil circuit of the electro-hydrostatic actuator underwater working conditions simulation test system are disconnected, the gear pump draws oil from the oil tank through a suction filter, a high-pressure hydraulic oil with a pressure higher than a preset threshold flows from an oil outlet of the gear pump through a first check valve and a pressure oil filter to a second check valve and a third check valve, the high-pressure hydraulic oil flows into the second oil circuit and the third oil circuit through the second check valve and the third check valve respectively, by adjusting the oil source components, the loading valve group and the first pressure compensator and the second pressure compensator, to simulate active loading of four underwater load conditions, thereby testing an execution hydraulic cylinder of a tested EHA, the four underwater load conditions comprising two positive load conditions and two negative load conditions, and monitoring in real time an oil temperature, pressure of the underwater working conditions simulation test system and piston rod displacement of the loading hydraulic cylinder through a pressure-resistant temperature sensor, a first pressure sensor, a second pressure sensor and a third pressure sensor and a pressure-resistant displacement sensor, when an oil temperature is detected to exceed a preset temperature, an oil circuit pressure is detected to exceed a preset pressure, or piston rod displacement of the loading hydraulic cylinder is detected to exceed a preset displacement range during the test, the controller closes the oil-immersed motor and places the electromagnetic directional valve in the de-energized state; the first pressure sensor monitors an inlet pressure of the loading valve group in real time, the second pressure sensor monitors a first cylinder pressure of the first chamber of the loading hydraulic cylinder in real time, the third pressure sensor monitors a second cylinder pressure of the second chamber of the loading hydraulic cylinder in real time; a second preset opening pressure of the second relief valve and a third preset opening pressure of the third relief valve always remain unchanged, the controller dynamically adjusts a fourth opening pressure of the first proportional relief valve and a fifth opening pressure of the second proportional relief valve, the loading hydraulic cylinder simulates alternating positive load and negative load conditions on the execution hydraulic cylinder of the tested EHA, the second relief valve and the third relief valve achieve large-range opening pressure adjustment, completing low-precision adjustment of a system pressure, the first proportional relief valve and the second proportional relief valve achieve small-range opening pressure adjustment, completing online high-precision adjustment of the system pressure by controlling an input current signal, so as to achieve high-precision loading force control of the loading hydraulic cylinder.

2. The loading method for the electro-hydrostatic actuator underwater working conditions simulation test system according to claim 1, wherein when the underwater load condition is in a first positive load condition, the first chamber of the loading hydraulic cylinder is a control chamber, a second oil circuit pressure in the third oil circuit is the sum of the fourth opening pressure of the first proportional relief valve and a second opening pressure of the second relief valve, a first magnitude of the input current signal in the first proportional relief valve is controlled to be constant, and a hydraulic oil after pressure reduction flows to the second chamber of the loading hydraulic cylinder; a first oil circuit pressure in the second oil circuit is the sum of the fifth opening pressure of the second proportional relief valve and the third opening pressure of the third relief valve, a second magnitude of the input current signal in the second proportional relief valve is controlled to adjust the fifth opening pressure of the second proportional relief valve, thereby reducing the first oil circuit pressure of the hydraulic oil in the second oil circuit, and the hydraulic oil after pressure reduction flows to the first chamber of the loading hydraulic cylinder; changing the fifth opening pressure of the second proportional relief valve, controlling the first cylinder pressure of the first chamber of the loading hydraulic cylinder to be greater than the second chamber, the loading hydraulic cylinder forms a dynamic loading force, a loaded piston rod of the execution hydraulic cylinder of the tested EHA extends and applies a generated pushing force to a loading piston rod of the loading hydraulic cylinder through a hinge mechanism, at this time a loading direction of the dynamic loading force of the loading hydraulic cylinder is opposite to an execution direction of an active force of the execution hydraulic cylinder of the tested EHA, completing a simulation loading of the first positive load condition.

3. The loading method for the electro-hydrostatic actuator underwater working conditions simulation test system according to claim 1, wherein when the underwater load condition is in a second positive load condition, the second chamber of the loading hydraulic cylinder is a control chamber, a first oil circuit pressure in the second oil circuit is the sum of the fifth opening pressure of the second proportional relief valve and the third opening pressure of the third relief valve, a second magnitude of the input current signal in the second proportional relief valve is controlled to be constant, and a hydraulic oil after pressure reduction flows to the first chamber of the loading hydraulic cylinder; a second oil circuit pressure in the third oil circuit is the sum of the fourth opening pressure of the first proportional relief valve and a second opening pressure of the second relief valve, a first magnitude of the input current signal in the first proportional relief valve is controlled to adjust the fourth opening pressure of the first proportional relief valve, thereby reducing the second oil circuit pressure of the hydraulic oil in the third oil circuit, and the hydraulic oil after pressure reduction flows to the second chamber of the loading hydraulic cylinder; changing the fourth opening pressure of the first proportional relief valve, controlling the second cylinder pressure of the second chamber of the loading hydraulic cylinder to be greater than the first chamber, the loading hydraulic cylinder forms a dynamic loading force, a loaded piston rod of the execution hydraulic cylinder of the tested EHA retracts and applies the generated pulling force to a loading piston rod of the loading hydraulic cylinder through a hinge mechanism, at this time a loading direction of the dynamic loading force of the loading hydraulic cylinder is opposite to an execution direction of an active force of the execution hydraulic cylinder of the tested EHA, completing a simulation loading of the second positive load condition.

4. The loading method for the electro-hydrostatic actuator underwater working conditions simulation test system according to claim 1, wherein when the underwater load condition is in a first negative load condition, the second chamber of the loading hydraulic cylinder is a control chamber, a first oil circuit pressure in the second oil circuit is the sum of the fifth opening pressure of the second proportional relief valve and the third opening pressure of the third relief valve, a second magnitude of the input current signal in the second proportional relief valve is controlled to be constant, and a hydraulic oil after pressure reduction flows to the first chamber of the loading hydraulic cylinder; a second oil circuit pressure in the third oil circuit is the sum of the fourth opening pressure of the first proportional relief valve and a second opening pressure of the second relief valve, a first magnitude of the input current signal in the first proportional relief valve is controlled to adjust the fourth opening pressure of the first proportional relief valve, thereby reducing the second oil circuit pressure of the hydraulic oil in the third oil circuit, and the hydraulic oil after pressure reduction flows to the second chamber of the loading hydraulic cylinder; changing the fourth opening pressure of the first proportional relief valve, controlling the second cylinder pressure of the second chamber of the loading hydraulic cylinder to be greater than the first chamber, the loading hydraulic cylinder forms a dynamic loading force, a loaded piston rod of the execution hydraulic cylinder of the tested EHA extends and applies a generated pushing force to a loading piston rod of the loading hydraulic cylinder through a hinge mechanism, at this time a loading direction of the dynamic loading force of the loading hydraulic cylinder is the same as an execution direction of an active force of the execution hydraulic cylinder of the tested EHA, completing a simulation loading of the first negative load condition.

5. The loading method for the electro-hydrostatic actuator underwater working conditions simulation test system according to claim 1, wherein when the underwater load condition is in a second negative load condition, the first chamber of the loading hydraulic cylinder is a control chamber, a second oil circuit pressure in the third oil circuit is the sum of the fourth opening pressure of the first proportional relief valve and a second opening pressure of the second relief valve, a first magnitude of the input current signal in the first proportional relief valve is controlled to be constant, and a hydraulic oil after pressure reduction flows to the second chamber of the loading hydraulic cylinder; the second oil circuit pressure in the second oil circuit is the sum of the fifth opening pressure of the second proportional relief valve and the third opening pressure of the third relief valve, a second magnitude of the input current signal in the second proportional relief valve is controlled to adjust the fifth opening pressure of the second proportional relief valve, thereby reducing a first oil circuit pressure of the hydraulic oil in the second oil circuit, and the hydraulic oil after pressure reduction flows to the first chamber of the loading hydraulic cylinder; changing the fifth opening pressure of the second proportional relief valve, controlling the first cylinder pressure of the first chamber of the loading hydraulic cylinder to be greater than the second chamber, the loading hydraulic cylinder forms a dynamic loading force, a loaded piston rod of the execution hydraulic cylinder of the tested EHA retracts and applies the generated pulling force to a loading piston rod of the loading hydraulic cylinder through a hinge mechanism, at this time a loading direction of the dynamic loading force of the loading hydraulic cylinder is the same as an execution direction of an active force of the execution hydraulic cylinder of the tested EHA, completing a simulation loading of the second negative load condition.
